(19) United States
(12) Patent Application Publication
(10) Pub. No.: US 2001/0046929 A1
(43) Pub. Date: Nov. 29, 2001

(54) Universal robotic end effectors and method for use

(76) Inventor: Stephen J. Derby, Troy, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 09/824,300

(22) Filed: Apr. 2, 2001

Related U.S. Application Data
(60) Provisional application No. 60/195,064, filed on Apr. 6, 2000.

(51) Int. Cl. B23Q 3/155

(52) U.S. Cl. 483/13; 29/700

(57) ABSTRACT

A universal robotic end effector for use with a robot system is disclosed. The end effector is suited for transport by a high speed apparatus and, upon delivery to its destination, the end effector is capable of disengaging from the transport device. Once disengaged, the end effector is capable of independent operation. The end effector may rely on self-contained power and control signals, or may receive them from any workstation to which it is docked and locked, or from a remote source. Finally, the end effector is capable of reacquiring the moving transport device when it is ready to be moved to a new workstation.

### BACKGROUND OF THE INVENTION

1. Technical field

The present invention relates generally to the field of robotics. In particular, this invention relates to a robotic device, system and method having a universal robotic end effector for mating to a workpiece.

2. Related Art

The field of robotics is a rapidly developing area of technology. Robotic systems are continually being adapted to operate in new market niches, and to operate at higher speeds in existing production areas. Robotics will continue to play an increasingly important role in the economic viability of existing, as well as emerging, technologies. For example, manufacture of miniature assemblies incorporating MEMS (Micro-Electro-Mechanics) devices is tedious and extremely difficult to perform efficiently for even a skilled person. Similarly repetitive and labor intensive tasks are present in many other industries, including photonics, laboratory automation, electronics assembly, food processing, material handling, and pouch singulation. Inherent in each of these processes is the need for a robotic end effector which can be repeatedly transported via high speed transfer systems, and which can perform high precision operations at the destinations to which it is delivered.

In general, the related art has provided a variety of robotic devices with which to address these constraints. For instance, in an assembly process, a standard robotic solution usually includes the use of detailed part geometry to align the assembly process using a device known in the art as a remote center of compliance device. One drawback of this approach is that it typically requires modifications or design changes to the product to be assembled.

Other solutions include the use of machine vision systems to provide positional feedback to the assembly process. This approach is expensive, and also suffers from the inherent drawback that portions of the product under assembly frequently obstruct the view of the vision system.

Another solution utilizes a mechanical closed loop robotic arm end effector positioning system. This approach, described in U.S. Pat. No. 4,919,586, granted Apr. 24, 1990 to Dr. Stephen Derby, discloses the operation of a larger, low precision robot to move a smaller, more precise robot into position to perform assembly tasks. This approach uses a docking process which involves forcing three legs of the smaller robotic device into three matching openings in a work table surface. This docking process achieves a very high precision between the robotic device and the assembly work station.

There are limitations to this device, however, because the larger robot must hold the smaller robotic device in place while the smaller robotic device performs its assigned tasks. Thus, a single large robot system cannot service a plurality of smaller robots simultaneously, which is a necessary attribute if dramatic increases in process throughput are desired. Also, it is difficult to coordinate the larger robotic system with an incrementally moving work station.

Therefore, a novel apparatus which is less complex and costly than presently available robotic systems is believed clearly desirable. Furthermore, any such novel apparatus must provide increases in speed and throughput, while maintaining or increasing precision operation and assembly.

### SUMMARY OF THE INVENTION

As noted initially and more fully described herein, the the present invention solves these problems in the related art by providing a universal robotic end effector device suitable for use with a robot system. The robotic device typically functions as a material handling instrument, although other embodiments are readily available.

The robotic device is capable of performing any task which requires manipulation or processing of a workpiece and which may be performed by a robot. The robotic device receives its control signals and power from several sources, namely, the workpiece, the workstation, or a remote command center. Alternatively, the robotic device may be autonomous, with its own microprocessor. A smaller robot may be part of the robotic device. This smaller robot may perform the required operations on the workpiece while the larger robotic device remains attached to it. The larger robotic device may also leave the smaller robot docked and locked to the workstation and move to another workstation to relocate a second smaller robot. While docked and locked, the smaller robot and its associated workpiece, or workstation, may be indexed to a new location, either by machine or by hand. Operations by the smaller robot can thus continue while in transit. Finally, the larger robot or an automation system may reacquire the robotic device at either its original location or at some new location. Use of a coupling mechanism (e.g., a clutch and brake combination) on each robotic device may be employed to create a desired acceleration, deceleration, or other controlled trajectory speed matching scheme when a robotic device is picked or placed by its robot system or other transporting means.

In a first general aspect, the present invention presents a robotic device, suitable for mating a docking end effector to a workstation, comprising: at least one positioning member; a system for coupling said docking end effector to said workstation; and an exchange mechanism operationally coupled to the docking end effector and to a transport mechanism.

In a second general aspect, the present invention presents a device comprising: at least one positioning member; an exchange mechanism to operationally couple a docking end effector to a transport mechanism; a supply of motive power operationally attached to the docking end effector; and a control system operationally attached to the docking end effector, said control system for controlling actions of the docking end effector.

In a third general aspect, the present invention presents a device comprising: at least one positioning member; a system for coupling a docking end effector to a workstation; a mechanism to operationally couple the docking end effector to the workpiece; a control system operatively attached to the docking end effector, said control system adapted to control the actions of the docking end effector; and a device for releasably attaching the docking end effector to a transport device.

In a fourth general aspect, the present invention presents a mechanical closed loop system for translationally locating along X, Y, Z axes and rotationally locating about each of said X, Y, Z axes the distal end of a docking end effector relative to a workpiece, the docking end effector end having an independently operated robotic manipulator affixed thereto for performance of precision tasks on a workpiece positioned on said fixture, said system comprising: an assembly mountable to the docking end effector, said assembly having a compliant member and a first positioning member connected to the compliant member, said first positioning member including a first docking means; a second positioning member associated with the workpiece, said second positioning member including a second docking means; said first docking means and said second docking means including: (i) a first positioning leg connected to one of said first positioning member and said second positioning member and a first positioning port associated with the other of said first positioning member and said second positioning member, said first positioning port having a tapered lead-in configured to engagably receive and position said first positioning leg's free end as the docking end effector attains a target position relative to the workpiece; (ii) a second positioning leg connected to one of said first positioning member and said second positioning member and a second positioning port associated with the other of said first positioning member and said second positioning member, said second positioning port having a tapered lead-in configured to engagably receive and position said second positioning leg's free end as the docking end effector attains its target position relative to the workpiece; (iii) a third positioning leg connected to one of said first positioning member and said second positioning member, said third positioning leg being sized and configured such that its free end engages the other of said first positioning member and said second positioning member when the docking end effector attains its target position relative to the workpiece; said compliant member providing rotational and translational freedom of movement for said first docking means to precisely position itself with respect to and interlock with said second docking means to ensure that the docking end effector attains the desired three-dimensional coordinates and three-dimensional rotational orientation relative to the workpiece; said robotic manipulator being located intermediate said first positioning member and said second positioning member when said first docking means and said second docking means are interlocked, whereby docking of said first and second positioning members produces a translational and rotational six-degree of freedom mechanical closed loop reference frame which separates operation of the independent robotic manipulator from gross movement inaccuracies and vibrations of a docking end effector transport system; and locking means located on the docking end effector, said locking means adapted to accept a corresponding locking means located on the workpiece.

In a fifth general aspect, the present invention presents a method for performing robotic actions on a workpiece, said method comprising: providing at least one workstation; providing at least one workpiece on said workstation; providing at least one robotic device; providing a transport system for said robotic device; transporting said robotic device to said workstation; depositing said robotic device at said workstation; coupling said robotic device to said workpiece; commanding said robotic device to act on said workpiece; and removing said first robotic device from said workstation.

In a sixth general aspect, the invention presents a method for performing robotic actions on a workpiece, said method comprising: providing at least one workstation; providing at least one workpiece on said workstation; providing at least one robotic device; providing a transport system for said robotic device; coupling said robotic device to said transport system; transporting said robotic device to said workstation; depositing said robotic device at said workstation; commanding said robotic device to act on said workpiece; and removing said first robotic device from said workstation.

In a seventh general aspect, the present invention presents a method for utilizing a first transportable robotic device in a system where a transporting device positions the first transportable robotic device, said method comprising: providing at least one transportable robotic device; providing a system for the first transportable robotic device to removably attach to the transporting device; providing a system for the first transportable robotic device to dock with a workstation; and providing at least one effecting device on said first transportable robotic device.

In an eighth general aspect, the present invention presents a method for performing robotic actions on a workpiece, said method comprising: providing a workstation for operationally mounting said workpiece; transporting a first robotic device to said workstation; docking said first robotic device to said workstation; locking said first robotic device to said workstation; operationally connecting said first robotic device to said workpiece; commanding said first robotic device to act on said workpiece; and removing said first robotic device from said workstation.

The foregoing and other objects, features and advantages of the invention will be apparent in the following and more particular description of the preferred embodiments of the invention as illustrated in the accompanying drawings.

### BRIEF DESCRIPTION OF THE DRAWINGS

The embodiments of this invention will be described in detail, with reference to the following figures, wherein like designations denote like elements, and wherein:

FIG. 1 is an overall perspective view of a docking robotic end effector of one embodiment of the present invention;

FIG. 2 is a detail view of a docking mechanism for a docking robotic end effector of an embodiment of the present invention;

FIG. 3 is a detail view of an alternative docking mechanism for a docking robotic end effector of an embodiment of the present invention;

FIG. 4 is a detail view of an alternative docking mechanism for a docking robotic end effector of an embodiment of the present invention;

FIG. 5 is a detail view of an alternative docking mechanism for a docking robotic end effector of an embodiment of the present invention;

FIG. 6 is a detail view of an alternative docking mechanism for a docking robotic end effector of an embodiment of the present invention;

FIG. 7 is a detail view of an alternative docking mechanism for a docking robotic end effector of an embodiment of the present invention;

FIG. 8 is a detail view of an alternative docking mechanism for a docking robotic end effector of an embodiment of the present invention;

FIG. 9 is a detail view of an alternative docking mechanism for a docking robotic end effector of an embodiment of the present invention;

FIG. 10 is a detail view of an alternative docking mechanism for a docking robotic end effector of an embodiment of the present invention;

FIG. 11A is a plan view of a portion of the docking robotic end effector device of an embodiment of the present invention employing a quick release brake mechanism;

FIG. 11B is another plan view of a portion of the docking robotic end effector device of an embodiment of the present invention employing a quick release brake mechanism;

FIG. 12A is a plan view of a portion of the docking robotic end effector device of an embodiment of the present invention employing a brake and roller coupling mechanism;

FIG. 12B is another plan view of a portion of the docking robotic end effector device of an embodiment of the present invention employing a brake and roller coupling mechanism; and

FIG. 13 is a perspective view of a laboratory automation embodiment with a multi-head tracked robot system capable of delivering, to numerous workstations, a plurality of the docking robotic end effector devices of an embodiment of the present invention.

### DETAILED DESCRIPTION OF THE INVENTION

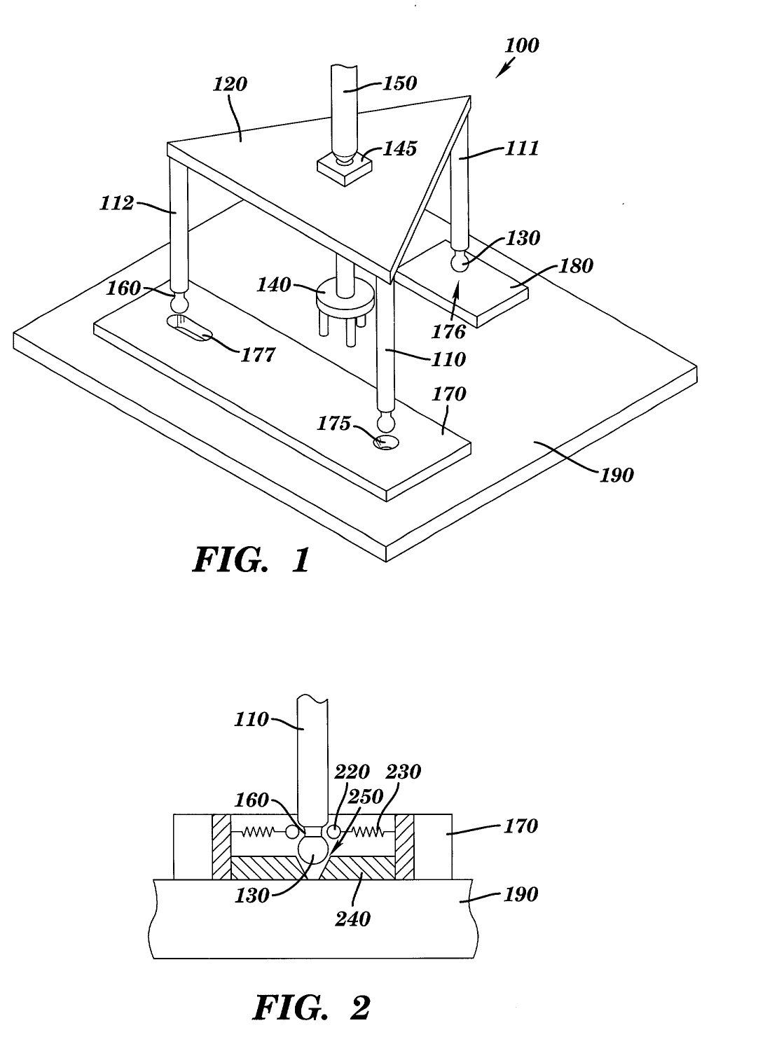

Referring to the drawings, FIG. 1 illustrates a first embodiment of the present invention, that is, a universal robotic end effector 100, suitable for use with a robot system capable of the high speed conveyance of a number of such robotic devices.

In the embodiment depicted in FIG. 1, a robotic end effector 100 is shown having three legs 110, 111, 112, and an attached robotic device 140. The legs 110, 111, 112, and the robotic device 140, are operationally attached to a base plate 120. Located at the distal end of each leg 110, 111, 112, is a ball 130 which facilitates a docking operation. The docking operation operationally attaches the robotic end effector 100 to a workstation 190. The workstation 190 includes a first docking plate 170 and a flat docking plate 180. An exchange mechanism 145 facilitates the operational coupling of the robotic end effector 100 to a transport mechanism 150 such as, inter alia, a transfer robot, man-portable carry handle, etc. The distal ends of the three legs 110, 111, 112, are oriented so that they contact the first docking plate 170 and the flat docking plate 180. Two of the legs 110, 112 are oriented so they are received in a cone-shaped hole 175 and a slot 177, respectively, of the first docking plate 170. A total of six spring-loaded balls 220 (FIG. 2) is required to properly dock the three-legged robotic end effector 100.

Referring now to FIG. 2, a detailed view of a portion of the docking mechanism is shown. The docking operation will be first described with respect to leg 110. Note that only a single configuration employing two spring-loaded balls 220 is depicted in FIG. 2. This is done for the sake of clarity. The number of spring-loaded balls will vary from one to three, depending on which leg 110, 111, 112 docking station is described.

Now, during the docking operation, the ball 130 of leg 110 is aligned with, and inserted into, cone-shaped hole 175. The cone-shaped hole 175 is surrounded by three spring-loaded balls 220, positioned equidistantly around the cone-shaped hole 175. Each of the three spring-loaded balls 220 presses against an indentation 160 on the leg 110. The spatial relationship, between the diameter of the leg 110 at the inner radius of the indentation 160 and the location of each spring-loaded ball 220 when its associated spring 230 is compressed by the leg 110, is such that the compressive force exerted on the leg 110 by each ball 220 firmly holds the leg 110 in place.

Referring again to FIGS. 1 and 2, the docking operation with respect to leg 112 will be explained. Leg 112 is received in slot 177 of first docking plate 170. Adjacent slot 177 are two spring-loaded balls 220, which are positioned so that their line of action is perpendicular to the sides of slot 177.

Finally, with respect to leg 111, the flat docking plate 180 receives leg 111 on a flat spot 176 located adjacent a single spring-loaded ball 220.

In each arrangement related to the docking of legs 110, 111, 112, the spring-loaded balls 220 assist in the docking process by guiding the balls of the docking legs 110, 111, 112 into the neighborhood of the docking fixture (i.e., slot 177, conical-shaped hole 175, or flat spot 176). This approach also has the added benefit of reducing wear and tear on the equipment which results from normal operation.

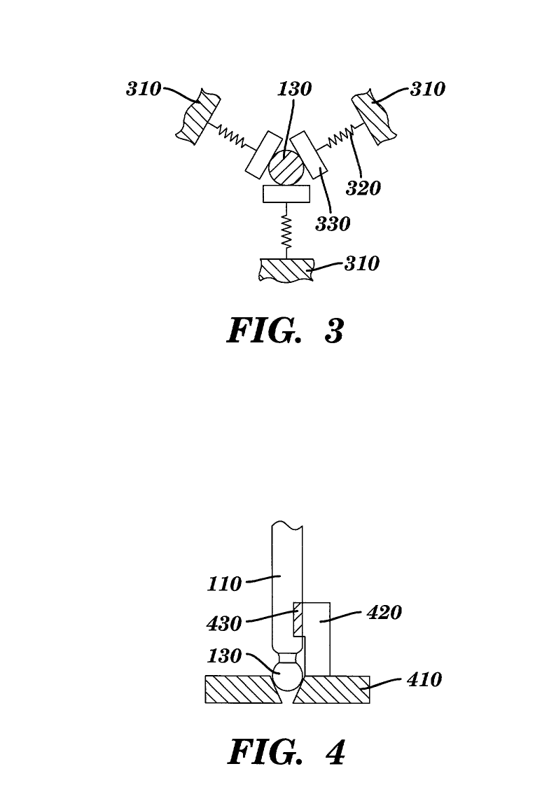

An alternative docking arrangement is depicted in FIG. 3. In this arrangement, the six spring-loaded balls 220 of FIG. 2 are replaced by six spring-loaded rollers 330. The ball 130 on the leg 110 is fixedly emplaced by spring-loaded rollers 330 in the same manner as described for the spring-loaded balls 220 supra. Each of the six spring-loaded rollers 330 is attached to a corresponding spring 320, which is in turn connected to a fixture 310 of the workstation 190 (FIG. 1).

A second alternative docking arrangement is depicted in FIG. 4. In this arrangement, the six spring-loaded balls 220 of FIG. 2 are replaced by a plurality of magnets 430. Thus, each of the three docking legs 110, 111, 112 is guided to and held by a magnet 430, which is mounted on each of the three docking legs 110, 111, 112, and which aligns with one of three corresponding metal plates 420. Each of the three metal plates 420 is mounted to the workstation 190 and is adjacent a docking fixture (i.e., slot 177, conical-shaped hole 175, or flat spot 176 in FIG. 1). Alternatively, the magnets 430 can be mounted on either each metal plate 420 or in each docking fixture (i.e., slot 177, conical-shaped hole 175, or flat spot 176, as shown in FIG. 1).

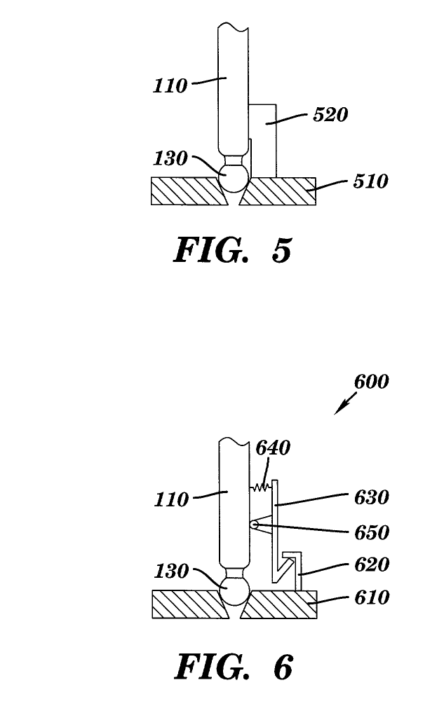

FIG. 5 represents an embodiment similar to FIG. 4, but with the metal plate 420 of FIG. 4 now replaced by an electromagnet 520. The electromagnet 520 is mounted to a fixture 510. The functions, and alternative configurations, of this embodiment are similar to that described in the previous paragraph pertaining to FIG. 4.

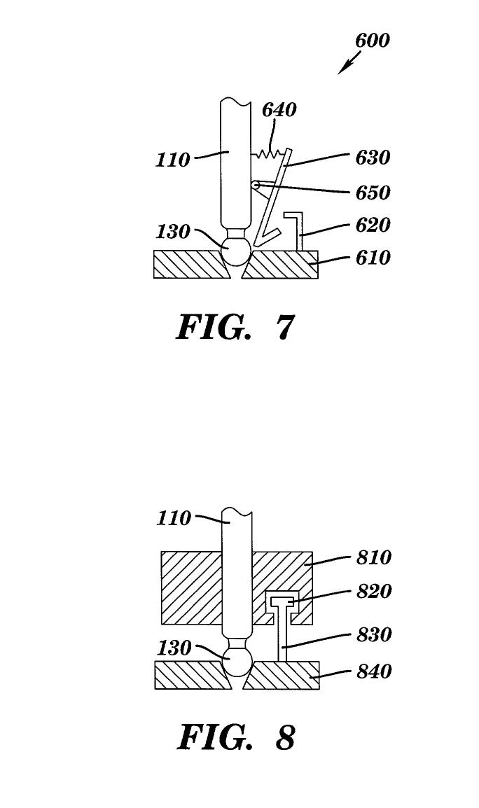

Another docking and locking configuration is illustrated in FIG. 6. This configuration utilizes a planar latching mechanism 600 which comprises a latch spring 640, a latch pivot 650, a latch arm 630, and a latch interlock 620. The latch spring 640, latch pivot 650, and latch arm 630 are attached to each of the three docking legs 110, 111, 112 (FIG. 1). The latch interlock 620 is attached to the workpiece 610. The latching mechanism 600 can be operated entirely via mechanical means, or it may utilize remotely controlled electromechanical means (e.g., a solenoid). FIG. 6 shows the latched state, while FIG. 7 shows the unlatched state.

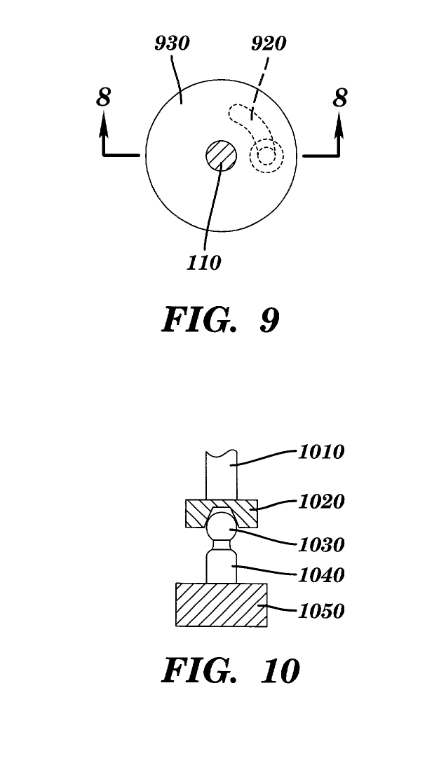

Referring now to FIG. 8, each of the three docking legs 110, 111, 112 (FIG. 1) is further locked in position by a rotating latch 810. A rotating latch is operationally attached to each of the three docking legs 110, 111, 112 (FIG. 1). The rotating latch 810 operationally engages a latching element 830 characterized by a T-shaped vertical cross section. The head 820 of latching element 830 is removably engaged by a latching slot 920 (FIG. 9) when rotating latch 810 is rotated. An overhead view of this latching arrangement is shown in FIG. 9.

The above described embodiments could be reversed. For example, FIG. 10 depicts a cone-shaped docking feature located on one leg 1010 (of the three docking legs 110, 111, 112 of FIG. 1). The surface of the workstation 1050 includes a guide ball 1030 to assist in the docking process. The guide ball 1030 is mounted on a ball pedestal 1040 attached to the workstation 1050.

One of the features the universal robotic end effector 100 of the present invention is its suitability for use with a robot system capable of the high speed conveyance of a number of such robotic devices. This is due in large part to the ability of the robotic device to engage and disengage a moving transport means.

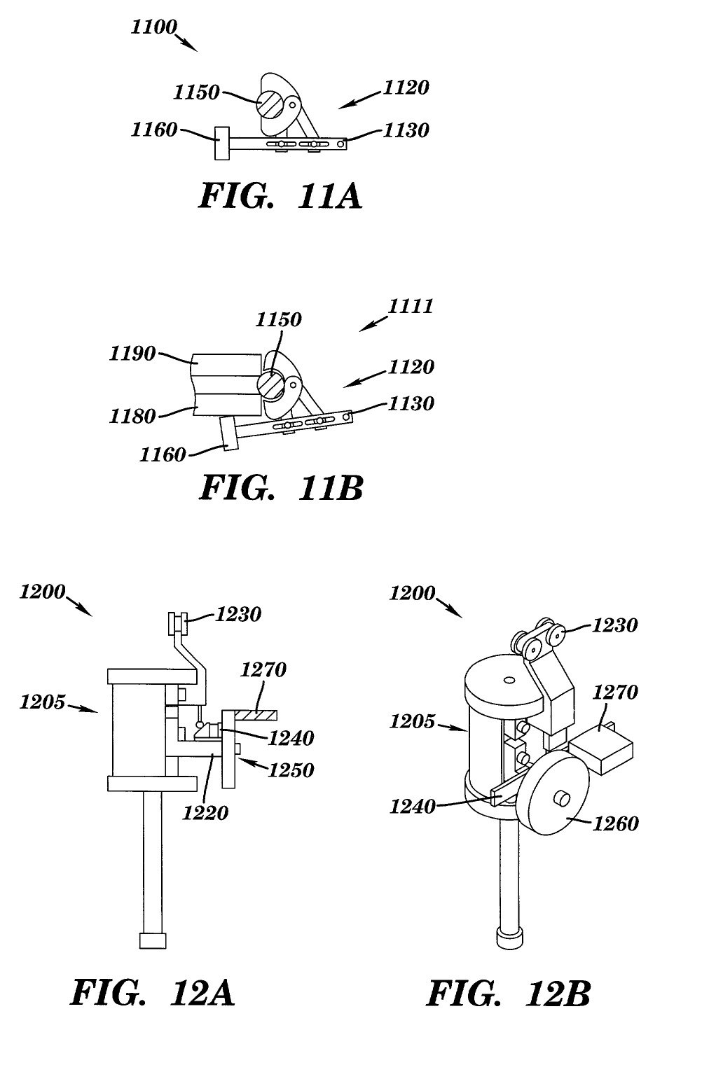

A quick-release brake mechanism 1100 is one embodiment which provides the robotic device with the ability to engage and disengage a moving transport means (e.g., a cable). The head 1120 of the quick-release brake 1100 shown in FIGS. 11A and 11B is operationally attached via lever arm 1130 to either the robotic device itself, or to a truck or carrier which carries the robotic device. The quick-release brake 1100 provides friction contact between a main transport cable 1150, which transports the robotic device, and the truck or robotic device itself. A wheel 1160 is incorporated for ease of movement of the robotic device.

In operation, as depicted in FIG. 11B, downward motion on a lever arm 1130 releases the brake pressure on the transport cable 1150 allowing the head 1120 to move independent of the transport cable 1150. The downward motion is initiated when unload arm 1180 contacts wheel 1160.

Alternatively, a belt drive system can be employed with a brake and roller system 1200 as shown in FIGS. 12A and 12B. The belt drive system requires that the head 1205 be supported by an overhead track via roller truck 1230. The head is propelled by a drive belt 1240. As the head 1205 enters the pulley 1270, the wheel 1260 lowers the drive engagement device as it releases the brake 1250. Friction in the wheel 1260 keeps the head 1205 moving forward when not restrained, at which time the wheel 1260 turns freely. After being released, the brake 1250 engages the belt in the opposite manner.

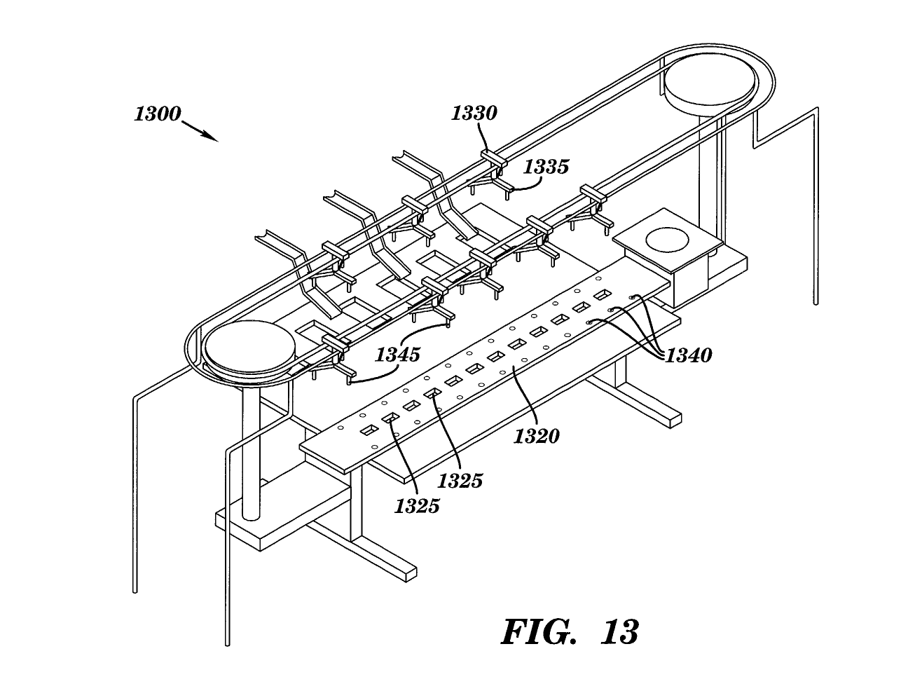

Finally, a laboratory automation scheme, utilizing a plurality of robotic end effectors of the present invention, is represented by FIG. 13. In FIG. 13, the feet 1335 of the robotic device 1330 are docked to a tray 1320 of a plurality of wells 1325. The tray 1320 be one of a plurality of trays situated in a pallet (not shown). The robotic devices 1330 will dock to the tray 1320 by mating docking pins 1345 to docking holes 1340. Once the robotic device 1330 or devices have docked to the tray 1320 or pallet, the robotic devices 1330 can dispense simultaneously into the wells 1325. The robotic devices 1330 are then refilled on the opposite side of the multi-head tracked robotic system 1300. The multi-head tracked robotic system 1300 is further disclosed in U.S. application Ser. No. 60/195,065, filed Apr. 5, 2000, which application is hereby incorporated by reference.

The foregoing and other objects, features and advantages of the invention will be apparent in the following and more particular description of the preferred embodiments of the invention as illustrated in the accompanying drawings.

What is claimed is:

1. A robotic device, suitable for mating a docking end effector to a workstation, comprising:
at least one positioning member;
a system for coupling said docking end effector to said workstation;
and an exchange mechanism operationally coupled to the docking end effector and to a transport mechanism.

2. The robotic device of claim 1, wherein:
the workstation includes at least one docking plate;
the docking plate includes at least one alignment device for aligning the positioning member to the docking plate; and
the positioning member is operationally aligned to the workstation.

3. The robotic device of claim 2, wherein the docking plate includes a docking mechanism, said docking mechanism including:
an apparatus for aligning the positioning member to the docking mechanism;
an aperture for receiving the positioning member; and
a locking mechanism for securing the positioning member to the docking plate.

4. The robotic device of claim 3, wherein the locking mechanism comprises:
a cone-shaped aperture for slidably receiving a first positioning member;
an oblong-shaped aperture, having inwardly tapered walls, for slidably receiving a second positioning member;
a plurality of securing devices, positioned proximate said cone-shaped aperture and said oblong-shaped aperture, capable of exerting a force against said first and second positioning members to secure the first and second positioning members in a stable position.

5. The robotic device of claim 4, wherein the securing devices comprise:
a plurality of spring-loaded devices;
each positioning member having a long axis perpendicular to the plane of the docking plate;
each spring-loaded device having a line of action substantially perpendicular to said long axis of each positioning member;
wherein each spring-loaded device is positioned so as to exert a compressive force on each positioning member; and
wherein each positioning member has a portion configured to accommodate one end of at least one of each spring loaded device.

6. The robotic device of claim 5, wherein each spring-loaded device comprises a spring-loaded ball.

7. The robotic device of claim 5, wherein each spring-loaded device comprises a spring-loaded roller.

8. The robotic device of claim 2, wherein the positioning member has a distal end comprising a spherical shape.

9. The robotic device of claim 3, further comprising:
wherein the positioning member further includes a first, second and third positioning member, each positioning member having a corresponding docking plate location, on the workstation, to which each positioning member is operationally aligned during mating;
said first positioning member having a corresponding flat docking plate location;
said second positioning member having a corresponding docking plate aperture whose peripheral shape approximately corresponds to the cross-sectional shape of the second positioning member so that the second positioning member is slidingly received in its corresponding docking plate aperture;
said third positioning member having a corresponding docking plate aperture whose peripheral shape is greater than that of the cross-sectional shape of the third positioning member so that the third positioning member is loosely and slidingly received in its corresponding docking plate aperture.

10. The robotic device of claim 3, wherein the locking mechanism comprises a magnetic coupling mechanism.

11. The robotic device of claim 3, wherein the locking mechanism comprises an electromagnetic coupling mechanism.

12. The robotic device of claim 3, wherein the locking mechanism comprises a planar latching mechanism, said planar latching mechanism including a latch spring, a latch pivot, a latch arm and a latch interlock.

13. The robotic device of claim 12, wherein the planar latching mechanism further comprises a solenoid.

14. The robotic device of claim 3, wherein the locking mechanism comprises a rotating latch mechanism.

15. The robotic device of claim 14, wherein the rotating latch mechanism further comprises a shaped latching aperture which operationally engages a correspondingly shaped latching element.

16. The robotic device of claim 1, wherein:
the positioning member includes at least one docking plate;
the workstation includes at least one alignment device for aligning the positioning member to the docking plate; and
the positioning member is operationally aligned to the workstation.

17. A device comprising:
at least one positioning member;
an exchange mechanism to operationally couple a docking end effector to a transport mechanism;
a supply of motive power operationally attached to the docking end effector;
and a control system operationally attached to the docking end effector, said control system for controlling actions of the docking end effector.

18. The device of claim 17, wherein the supply of motive power is contained within the docking end effector.

19. The device of claim 17, wherein the control system further includes at least one microprocessor.

20. The device of claim 17, wherein the control system is capable of remote operation.

21. A device comprising:
at least one positioning member;
a system for coupling a docking end effector to a workstation;
a mechanism to operationally couple the docking end effector to the workstation;
a control system operatively connected to the docking end effector, said control system adapted to control the actions of the docking end effector; and
a device for releasably attaching the docking end effector to a transport device.

22. The device of claim 21, wherein the device for releasably attaching the docking end effector to a transport means includes:
a carrier mechanism which supports the docking end effector and effectively couples the docking end effector to the transport means;
a brake mechanism operationally attached between the carrier mechanism and the transport means; and
an uncoupling device which causes the carrier mechanism to detach from the transport means.

23. The device of claim 22, wherein the brake mechanism further comprises a quick-release brake.

24. A mechanical closed loop system for translationally locating along X, Y, Z axes and rotationally locating about each of said X, Y, Z axes the distal end of a docking end effector relative to a workpiece, the docking end effector end having an independently operated robotic manipulator affixed thereto for performance of precision tasks on a workpiece positioned on said fixture, said system comprising:
an assembly mountable to the docking end effector, said assembly having a compliant member and a first positioning member connected to the compliant member, said first positioning member including a first docking means;
a second positioning member associated with the workpiece, said second positioning member including a second docking means;
said first docking means and said second docking means including:
(i) a first positioning leg connected to one of said first positioning member and said second positioning member and a first positioning port associated with the other of said first positioning member and said second positioning member, said first positioning port having a tapered lead-in configured to engagably receive and position said first positioning leg's free end as the docking end effector attains a target position relative to the workpiece;
(ii) a second positioning leg connected to one of said first positioning member and said second positioning member and a second positioning port associated with the other of said first positioning member and said second positioning member, said second positioning port having a tapered lead-in configured to engagably receive and position said second positioning leg's free end as the docking end effector attains its target position relative to the workpiece;
(iii) a third positioning leg connected to one of said first positioning member and said second positioning member, said third positioning leg being sized and configured such that its free end engages the other of said first positioning member and said second positioning member when the docking end effector attains its target position relative to the workpiece;
said compliant member providing rotational and translational freedom of movement for said first docking means to precisely position itself with respect to and interlock with said second docking means to ensure that the docking end effector attains the desired three-dimensional coordinates and three-dimensional rotational orientation relative to the workpiece;
said robotic manipulator being located intermediate said first positioning member and said second positioning member when said first docking means and said second docking means are interlocked, whereby docking of said first and second positioning members produces a translational and rotational six-degree of freedom mechanical closed loop reference frame which separates operation of the independent robotic manipulator from gross movement inaccuracies and vibrations of a docking end effector transport system; and
locking means located on the docking end effector, said locking means adapted to accept a corresponding locking means located on the workpiece.

25. A method for performing robotic actions on a workpiece, said method comprising:
providing at least one workstation;
providing at least one workpiece on said workstation;
providing at least one robotic device;
providing a transport system for said robotic device;
coupling said robotic device to said transport system;
transporting said robotic device to said workstation;
depositing said robotic device at said workstation;
commanding said robotic device to act on said workpiece; and
removing said first robotic device from said workstation.

26. The method of claim 25, wherein the step of transporting said robotic device further includes:
maintaining said transport system operating at a constant speed;
releasably attaching said robotic device to said transport system; and
detaching said robotic device at said workstation.

27. The method of claim 25, wherein the step of depositing the robotic device at the workstation further comprises:
aligning at least one positioning member with a corresponding mating portion of the workstation;
providing a locking device proximate said corresponding mating portion of the workstation, wherein said corresponding mating portion is configured to receive said at least one positioning member; and
operationally connecting said at least one positioning member to said corresponding mating portion of the workstation with said locking device.

28. The method of claim 27, wherein the step of depositing the robotic device at the workstation further comprises:
aligning a first positioning member of the robotic device with a first corresponding mating portion of the workstation;
aligning a second positioning member of the robotic device with a second corresponding mating portion of the workstation;
aligning a third positioning member of the robotic device with a third corresponding mating portion of the workstation;
providing a first orifice on said second corresponding mating portion and a second orifice on said third corresponding mating portion, wherein said first orifice and second orifice are adapted to releasably accept an end of said first positioning member and an end of said second positioning member, respectively; and
providing at least one locking device to secure an end of at least one of said end of said first positioning member, said end of said second positioning member, and an end of said third positioning member.

29. A method for utilizing a first transportable robotic device in a system where a transporting device positions the first transportable robotic device, said method comprising:
providing at least one transportable robotic device;
providing a system for the first transportable robotic device to removably attach to the transporting device;
providing a system for the first transportable robotic device to dock with a workstation; and
providing at least one effecting device on said first transportable robotic device.

30. The method of claim 29, further comprising:
providing a workpiece operationally coupled to said workstation; and
commanding said effecting means to operate on said workpiece.

31. A method for performing robotic actions on a workpiece, said method comprising:
providing a workstation for operationally mounting said workpiece;
transporting a first robotic device to said workstation;
docking said first robotic device to said workstation;
locking said first robotic device to said workstation;
operationally connecting said first robotic device to said workpiece;
commanding said first robotic device to act on said workpiece; and
removing said first robotic device from said workstation.

32. The method of claim 31, wherein the step of commanding said first robotic device to act on said workpiece further comprises:
transmitting operational commands from a source; and
receiving said operational commands at said first robotic device.
